(19) United States
(12) Patent Application Publication
(10) Pub. No.: US 2006/0064307 A1
(43) Pub. Date: Mar. 23, 2006

(54) Method and system for session management wherein a client session identifier is used

(76) Inventor: Timo Pakkala, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/536,376

(22) PCT Filed: Nov. 25, 2002
(86) PCT No.: PCT/IB02/04917

§ 371 Date: May 25, 2005

(51) Int. Cl. G06Q 99/00

(52) U.S. Cl. 705/1

(57) ABSTRACT

An application server (113) receives, from a client mobile terminal (101), a request to initiate a first client application session, as well as first client specific data, where the data comprises a first mobile terminal identifier, e.g. a mobile station integrated services digital network number and a hash code. An association is made in the server (113) of a first client session identifier with the first mobile terminal identifier. The first client session identifier is then stored in a session management database (115). Maintenance of communication between the client terminal (101) and the application session is then enabled, including receiving a communication request and verifying that the communication request originate from the first client terminal (101).

### TECHNICAL FIELD

The present invention relates to a method for client session management in an application server connected to a digital mobile communication system and a system for client session management.

### BACKGROUND

The desire of users to use mobile communication terminals for accessing services available via the Internet is increasing. This desire is about to be fulfilled by both network operators and service providers in that they are offering new an innovative data services among which mobile E-mail access is only one example. Mobile client terminal devices that are used to obtain access to such services have advantages as well as limitations compared to traditional access devices such as personal computers. Special functionality is needed in order to take advantage of the strengths of mobile clients, i.e. mobile communication terminals. However, special functionality is also needed to overcome the limitations of these access devices that necessarily have limited data communication capability, processing capability and presentation capability as compared to traditional personal computer access devices. In short, there is a need to provide new and innovative services to mobile client access devices.

International patent application published with number WO 01/50701 discloses a system for customizing behaviours and interfaces in service invocations. It is shown how a plurality of mobile communication terminals communicate with application servers in a network. Application session management enables a user to access an application from a first terminal and then maintain the session when the user access the application from a second terminal.

However, a problem related to prior art, which is more or less inherent in mobile communication systems, is that of intermittency of the communication channel between a mobile client device and an application server. The intermittency may be either accidental, such as when a connection is lost due to a radio communication interruption during a circuit switched connection. The intermittency may also be a matter of choice, such as when connectionless packet switched communication is used. Examples of such connectionless communication is becoming more common as the mobile communication systems evolve into the so-called “third generation” and terminals are provided with software applications capable of communicating with server applications on the Internet.

Furthermore the connection between a mobile client device and accessed services in an application server may cause problems as there are different protocols which should work together when mobile client device is requesting services. Better session management is needed to provide better service to mobile client devices.

### SUMMARY OF THE INVENTION

An object of the present invention is hence to overcome the drawbacks of prior art methods and systems for session management, as briefly discussed above.

This is achieved by way of a method according to claims 1 and 15, a system according to claim 10 and a computer program according to claims 17 and 18, as specified below.

A method according to the invention is a method of client session management in an application server. The client application server is capable of communicating via a connectionless communication protocol with at least one client mobile communication terminal, where the terminal is located in a digital mobile communication system. The method of client session management comprises, in its most general aspect, the step of maintaining at least a first client session identifier, which is associated with a client terminal identifier.

A client session management system according to the invention is arranged to communicate via a connectionless communication protocol with at least one client mobile communication terminal in a digital mobile communication system. The system comprises, in its most general aspect, means for maintaining at least a first client session identifier, which is associated with a client terminal identifier.

In another aspect, the invention overcomes drawbacks of prior art by providing a method of client session management in an application server in a digital mobile communication system. The application server communicates with a client mobile communication terminal by subsequent connectionless communication protocol messages. The server receives a request for a service through a service application server from a service application. Then, the server sets a first client session identifier, which associated with a client terminal identifier based on the request. The first client session identifier associated with a client terminal identifier of said client mobile communication terminal is then maintained. The session identifier indicates the session with said client terminal between the subsequent messages.

In preferred embodiments, the inventive method and the inventive system may comprise a number of steps and a number of means for performing steps. The steps includes receiving, from the client terminal, a request to initiate a first client application session, as well as receiving first client specific data, where said data comprises a first mobile terminal identifier, e.g. a mobile station integrated services digital network number and a hash code. An association is made, e.g. by a calculation, of a first client session identifier with the first mobile terminal identifier. The first client session identifier is then stored in a session management database. Maintenance of communication between the client terminal and the application session is then enabled, including receiving a communication request and verifying that the communication request originate from the first client terminal.

Preferred embodiments may further include use of a time-out procedure capable of disabling communication between the client terminal and the application server, where the disabling is being dependent on a time-out limit.

In one preferred embodiment, handling of E-mail messages is illustrated where lists of messages are handled. A message contains a number of headers of items retrieved from an E-mail server inbox to an application server and a predefined number of these headers can be sent once from the application server to the mobile terminal by taking into account the limitations of the used systems. Next available message comprises a predefined number of headers and actually the list of messages in the list of headers.

An advantage of the invention is that it provides a more flexible use of mobile communication terminals when accessing services in a connectionless environment, such as the Internet.

### SHORT DESCRIPTION OF THE DRAWINGS

FIG. 1 illustrates schematically a mobile communication system connected to a packet switched network including a system according to an embodiment of the present invention.

FIG. 2 is a flow chart of a method of establishing and managing a client session according to an embodiment of the present invention.

### PREFERRED EMBODIMENTS

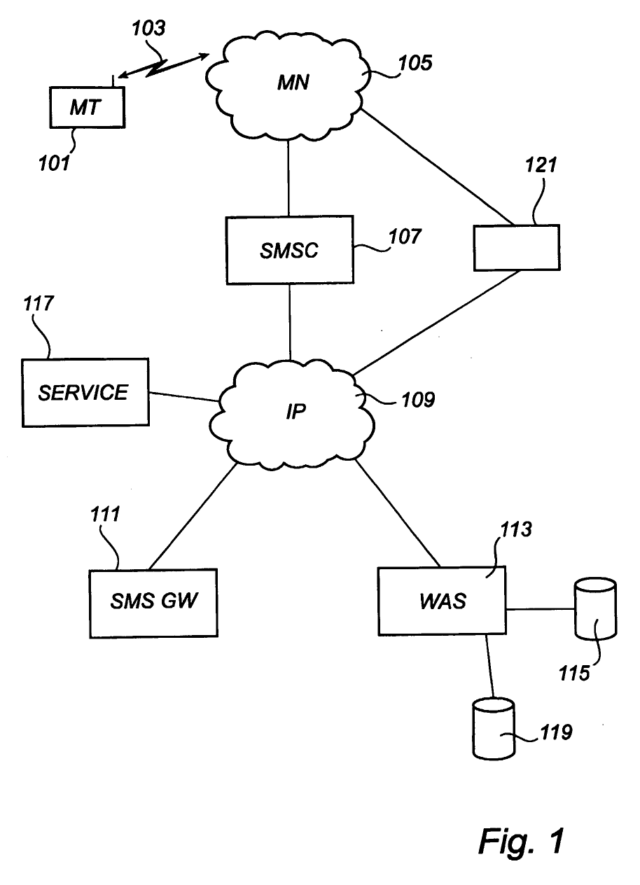

Referring initially to FIG. 1, a mobile client terminal 101 is via a radio interface 103 connected to a digital mobile communication network 105. The digital mobile communication network 105 may be of any kind known in the art, such as the very widely used GSM/GPRS system.

Connected to the mobile network 105 is a short message service centre 107 (SMSC). The SMSC 107 is capable of receiving text messages from the mobile terminal 101, and any other mobile terminal connected to the mobile network 105, and convey the messages to receivers in a packet switched data network 109, e.g. to an application server 113 as will be discussed further below. The short message service centre 107 is connected to the packet switched (Internet) network 109 and uses preferably the HTML, HTTP, and TCP/IP Internet network protocols. Short messages are transferred between the service centre 107 and mobile stations. The user submits to the service centre 107 a short message containing an identifier of a service in order to handle it in an application server 113. The application server 113 recognises the service requested and forwards the message to a service application server 117 capable of handling the service. Based on service request the service is delivered through the application server 113 to the mobile client device 101, which receives the requested information in a short message. The mobile station 101 processes the received message and renders it to the user according to the selected procedure.

The service centre 107 is connected to the mobile communication network through a gateway (not shown) as the person skilled in the art realizes. The service centre 107 is assigned, e.g., a dedicated ISDN number in the number space of the GSM network, and the mobile terminal uses the ISDN number for addressing the short message to the service centre 107.

The mobile network 105 and the packet switched data network 109 are interconnected via a path 121, which may include any necessary functionality for conveying information between the networks. For example, the path 121 may include a gateway switching centre (GMSC) as the skilled person will understand.

By messaging the user may be charged via the ususal charging system utilized by the telecommunication provider such as telephone service provider. For example, the user has sent SMS messages to the application server 113. The operator of the wireless network 105 may now invoice this service separately by using user's phone bill, the extra or lower charge comprising the charge of the service usage can be used.

Connected to the packet switched network 109 is a short message service gateway 111 (SMS gateway) and an application server 113. Whenever the terminal sends a session request to the application server 113, the request is conveyed by the SMSC 107 and the packet switched network 109 to the SMS gateway 111. The SMS gateway 111 converts the request and forwards it to the application server 113. The request, when sent from the SMS gateway 111, holds information including a mobile terminal identifier, e.g. the mobile station integrated services digital network number (MSISDN).

The application server 113 updates a session manager database 115 and transmits a response back to the terminal 101 through the SMS gateway 111.

Subsequent requests from the terminal 101 are handled in the application server 113 by making use of the session object in the application server session manager database 115. Hence, it is possible for the application server 113 to track the information that needs to be transmitted to the mobile terminal 101.

The application server 113 is running session management software capable of supporting multiple client terminals, such as the terminal 101 shown in FIG. 1, and enables a user of a terminal to reach an application running on the application server 113. Such an application may be any kind of application. For the purpose of illustration, an E-mail application will be used in the description to follow.

The application server 113 receives a request from the client terminal 101, preferably based on a command sent by the user. The command may be included in a predefined list of available commands for communication maintained by the application server 113, e.g. in its session manager database 115. In the present case the application server 113 maintains an E-mail messaging service, and hence there is no continuous connection between the user and the server, as would be the case if the application server 113 was running an application requiring more or less constant interaction with the user.

The application server 113 also maintains a communication database 119 for identifying the user and keeping track of earlier commands sent by the user and where the messages have been forwarded. This communication database 119 retains information for a predetermined time period, enabling the user to gain benefit of earlier sent commands in later requests if the earlier commands have been sent within the predetermined time period.

To exemplify an E-mail session, the user sends “m”, which creates an active list for a predefined time limit, e.g. for 20 minutes. These mails can be accessed by sending a predefined message identifiable in the application server 113, e.g. 1, 2, next, etc. Based on the command, the application server 113 will start to maintain the session.

When user requests mails by entering “m” or folders, the result is usually a numbered item list, such as:
1. Denver Jona: Project status
2. Stones Tina: Copyright issues
3. McAllen Mar: Conference schedule

In a mail list, the sender and subject are cut to fit in a SMS message.

Sending a number (1) from the list within the time limit, will bring that item:

in a mail list, the content of the mail (1):

“The project is doing well in this step. The research is within schedule. There is lack of sales manager. Will be fixed by May. Best regards, Jonathan”

in a folder list, the content of the folder: subfolders and mails.

The numbers in a mail list can also be used in conjunction with commands such as reply, forward, delete, mark read, and headers.

The list is valid until a new list is created or for a certain time limit, e.g. 20 minutes. If the user gets a message containing: “No such mail item in your list”, this may mean that the list has expired because more than 20 minutes have passed, or the user sent another command which created a new list for a new session maintenance, and the number requested was not on the list.

If automatic notification brings a new list or mail during the set time limit while the user has an active list, the application server 113 creates a parallel session (buffer) for this list or mail. The message starts with 0/(zero slash) and referring to this mail or list must be done by inserting the same figure in the beginning of the text message. User gets:
1/3
0/
(Denver Jona:
FWD: Applied)

Then sends: 0/next to get the next text message page. In certain situations, the message may start with other numbers also, e.g. 1/or 2/.

During the set time limit, e.g. 20 minutes, a notify message brings another list of E-mail messages, starting with 0/. These messages are received in the inbox after the 20 minutes session had started but they are received prior to the set time limit. These E-mail messages may be accessed by sending 0/1, 0/2, 0/next, etc. E-mail messages have arrived after the “m” has been sent and the active list was generated.

Active List:

1. Denver Jona: Project status
2. Stones Tina: Copyright issues
OR-list by notify message:
0/
1. Smith Steve:Re: Update
2. Brown Jane:

The session manager software running on the application server 113 further comprises a multi-user platform to enable handling of multiple clients, i.e. running multiple client applications, on the server 113 and a command platform to interpret the commands sent by the users. When a user initially connects to the application server 113 with a mobile communication terminal by sending, e.g., an SMS message. The platform session manager software application in the server 113 stores an identification code, preferably based on the identification number of the terminal, i.e. the MSISDN of the mobile terminal, and the command sent by the user in the message. The information is stored in the communication database 119 where each user having its own user specific information.

The information regarding each user may comprise a user name and password corresponding to various MSISDN and at least time information, i.e. when a session was initiated. Further the information may comprise the relevant network address, i.e. where to go to find email server etc. to retrieve the unread E-mail messages in an inbox of the E-mail account. When “m” has arrived the server will locate the user and start to find the E-mail message headers of the identified user. The session manager software then selects the selected messages for forwarding them to the mobile terminal 101. The header in this context means, e.g., a defined number of marks from the “From field” and the title of the message.

The session manager software keeps the session alive depending on the commands received and makes a decision whether the incoming commands will be handled in the same session or in another session. For example, they may be handled in the same session, or in parallel session by separating a command used by the user or a single session so that only one session can be maintained so that if the user command triggers a new session then only the new session will exist.

The session manager software also forwards a request corresponding to the command in the received message for the user to the software application managing an E-mail account of the user. The information defined by the command is selected, taking into consideration the limitations of the communication protocol used by the user or further the user parameters like user terminal, command user typed, etc. or per predefined criteria. Such limitations may be, in a case where communication is via SMS messaging, that only a certain number of E-mail headers can be sent to the mobile terminal 101 in one transmission. The session manager maintains the information of the messages sent to the mobile terminal 101 and also possible list of notified messages occurred after the sessions started.

After obtaining the requested information from the software application managing the E-mail account, the server 113 sends the obtained information by using the same communication protocol to the user, for example an SMS message. When the user subsequently connects with the server 113, within the predetermined time period using a subsequent command, the session manager software interprets the command and forwards it to the software managing the users E-mail account. Thereby a transfer of subsequent information is enabled regarding the E-mail account, where the information is depending on the previous commands during the first connection.

After the predetermined time period has passed, the users identification code and relating commands are deleted so subsequent communication is considered as being an initial communication.

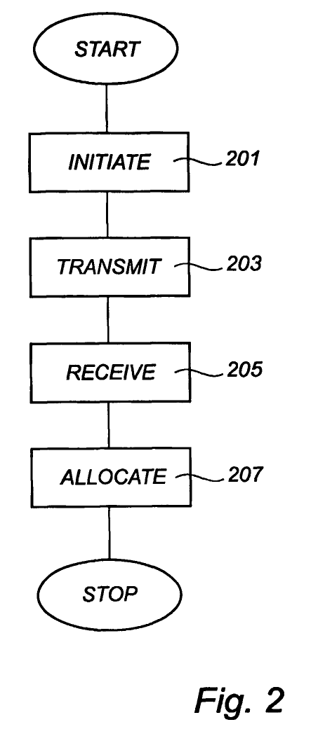

Referring now to FIG. 2, a method according to the invention will be discussed in terms of a number of steps performed in the application server 113 and other components of the system illustrated in FIG. 1.

First, in an initiation step 201 the mobile terminal 101 initiates a connectionless session with the application server 113. The terminal 101 transmits in a transmission step 203 a SMS request destined for the application server 113. After receiving said request, in a reception step 205, session manager software running in the application server 113 allocates, in an allocation step 207, a session object for the mobile terminal 101, from which a predefined information exists in the application server. The session object performs the function of maintaining session data and terminal information in order to provide continuous communication with the mobile terminal 101 although the communication between the application server 113 and the mobile terminal is connectionless messaging. The communication session identifier is the unique MSISDN number with a hash code, so the user communicating through messaging with the application server 113 is identified by the terminal 101.

The session manager software keeps track of messages sent to the mobile terminal 101 and the messages received from the service server 117, the session manager software sends those messages from the application server 113 to the mobile terminal 101 which are not yet sent and changes the status of these messages as sent status in the application server 113, or sends a subsequent message in a list of messages.

The session manager software also keeps information about the commands available. The additional information request of a certain E-mail message by the mobile terminal 101 will be handled as it was handled in the same session in an earlier request and the request initiates a retrieval of that specific information from the specified location of the user information, e.g. from the E-mail (service application) server or from the application manager server 113. The session manager software operates retrieval of the information and stores the new content in the application server 113 accessible via commands sent from the user mobile terminal 101. Thus, limitations in the user terminal 101 and the communication protocol used will affect how much of that content can be sent to the mobile terminal 101 at once.

Alternative ways to communicate between mobile terminal and application server is to use e.g. WAP or other available communication method like GPRS, UMTS etc.

The session management software may be created by employing any known software programming tool and the software may be embodied in any form, such as a computer program comprising program code stored on a software medium or transmitted from a software source server using any relevant transmission technique.

What is claimed is:

1. A method of client session management in an application server (113) capable of communicating via a connectionless communication protocol with at least one client mobile communication terminal (101) in a digital mobile communication system (105), the method comprising maintaining at least a first client session identifier being associated with a client terminal identifier.

2. A method according to claim 1, comprising the steps of
receiving, from the client terminal (101), a request to initiate a first client application session,
receiving, from the client terminal (101), first client specific data, said data comprising a first mobile terminal identifier,
associating a first client session identifier with said first mobile terminal identifier,
storing said first client session identifier in a session management database (115),
enabling maintenance of communication between the client terminal (101) and the application session, including receiving at least one communication request and verifying that said at least one communication request originates from said first client terminal (101).

3. A method according to claim 2, wherein the association of a first client session identifier with said first mobile terminal identifier includes a calculation of the first client session identifier.

4. A method according to claim 2, wherein the step of enabling maintenance of communication between the client terminal (101) and the application server (113) involves use of a time-out procedure capable of disabling communication between the client terminal (101) and the application server (113), said disabling depending on a time-out limit.

5. A method according to claim 4 wherein the communication session comprises a plurality of connection requests from the client terminal (101) and service retrievals to terminals within predefined time limit.

6. A method according to claim 2, wherein the reception of first client specific data includes reception of a mobile station integrated services digital network number and a hash code.

7. A method according to claim 2, wherein the session management depends on commands received from the client mobile communication terminal (101).

8. A method according to claim 2, wherein the application server (113) sends messages to the mobile terminal (101) which are not yet sent and changes the status of these messages as sent status in the application server (113).

9. A method according to claim 2, wherein the next available message in a list of messages is sent.

10. A client session management system arranged to communicate via a connectionless communication protocol with at least one client mobile communication terminal (101) in a digital mobile communication system (105), the system comprising means for maintaining at least a first client session identifier being associated with a client terminal identifier.

11. A system according to claim 10, comprising means for:
receiving, from the client terminal (101), a request to initiate a first client application session,
receiving, from the client terminal (101), first client specific data, said data comprising a first mobile terminal identifier,
associating a first client session identifier with said first mobile terminal identifier,
storing said first client session identifier in a session management database (115),
enabling maintenance of communication between the client terminal (1011) and the application session, including means for receiving at least one communication request and means for verifying that said at least one communication request originate from said first client terminal (101).

12. A system according to claim 11, where the means for association of a first client session identifier with said first mobile terminal identifier includes means for calculating the first client session identifier.

13. A system according to claim 11, where the means for enabling maintenance of communication between the client terminal (101) and the application server (113) include time-out means capable of disabling communication between the client terminal (101) and the application server (113), said disabling depending on a time-out limit.

14. A system according to claim 11, where the means for reception of first client specific data includes means for reception of a mobile station integrated services digital network number and a hash code.

15. A method of client session management in an application server (113) in a digital mobile communication system (105), the method comprising the steps of:
communicating with a client mobile communication terminal (101) by subsequent connectionless communication protocol messages,
receiving a request for a service through a service application server (117) from a service application,
setting a first client session identifier being associated with a client terminal identifier based on the request,
maintaining the first client session identifier being associated with a client terminal identifier of said client mobile communication terminal (101), wherein said session identifier indicates the session with said client terminal between the subsequent messages.

16. A method according to claim 15, wherein at least part of a service of the service application is retrieved from the service application to the application server (113) and the session identifier is the same during the communication both between the client terminal (101) and the application server (113) and the client terminal (101) and the service application through the service application server (117).

17. A computer program product comprising software instructions stored on a readable medium for execution by a processor to perform the method of claim 1.

18. A computer program product comprising software instructions stored on a readable medium for execution by a processor to perform the method of claim 15.
